(19) United States
(12) Patent Application Publication
(10) Pub. No.: US 2014/0049129 A1
(43) Pub. Date: Feb. 20, 2014

(54) ROTOR FOR INTERIOR PERMANENT MAGNET SYNCHRONOUS MOTOR AND INTERIOR PERMANENT MAGNET SYNCHRONOUS MOTOR INCLUDING THE SAME

(71) Applicant: SAMSUNG ELECTRO-MECHANICS CO., LTD., Suwon (KR)

(72) Inventors: Kwang Hyun Lee, Suwon (KR); Changsung Sean Kim, Suwon (KR); Jang Hyeok Won, Suwon (KR)

(21) Appl. No.: 13/942,344

(22) Filed: Jul. 15, 2013

(30) Foreign Application Priority Data
Aug. 17, 2012 (KR) 10-2012-0089968

(51) Int. Cl. H02K 1/27

(52) U.S. Cl. CPC H02K 1/27
USPC 310/156.01

(57) ABSTRACT

Disclosed herein is a rotor for an interior permanent magnet synchronous motor, the rotor including: a rotor core having a through-hole formed in an axial direction so that a shaft is press-fitted thereinto, a permanent magnet receiving part formed at an outer peripheral portion thereof in a circumferential direction so that a permanent magnet is inserted thereinto, and slits formed to be adjacent to the permanent magnet receiving part and be extended toward a circumferential end in a radial direction; and at least one permanent magnet inserted into the permanent magnet receiving part.

### CROSS REFERENCE TO RELATED APPLICATION

This application claims the benefit of Korean Patent Application No. 10-2012-0089968, filed on Aug. 17, 2012, entitled “Rotor for Interior Permanent Magnet Synchronous Motor and Interior Permanent Magnet Synchronous Motor Including the Same”, which is hereby incorporated by reference in its entirety into this application.

### BACKGROUND OF THE INVENTION

1. Technical Field

The present invention relates to a rotor for an interior permanent magnet synchronous motor and an interior permanent magnet synchronous motor including the same.

2. Description of the Related Art

Recently, due to a rapid increase in price of petroleum and an environmental problem, conversion from fields such as an internal combustion engine, an industrial apparatus, and the like, that uses petroleum as fuel into an electric vehicle (EV), a hybrid electric vehicle (HEV), and an industrial apparatus that use electric motors has been made.

Among the electric motors as described above, a demand for an interior permanent magnet synchronous motor (IPMSM) including an Nd based permanent magnet using a rare earth material having excellent output density per volume has significantly increased.

Further, due to a rapid increase in price of the rare earth material, a magnetic flux concentration type IPMSM increasing output density per volume of the motor using a small amount of rare earth material has been designed.

However, the IPMSM according to the prior art including the following Patent Document has problems such as a small torque and a large torque ripple.

### PRIOR ART DOCUMENT

### Patent Document

(Patent Document 1) US 2010-0225191 A

### SUMMARY OF THE INVENTION

The present invention has been made in an effort to provide a rotor for an interior permanent magnet synchronous motor in which three permanent magnets are mounted in a

U shaped permanent magnet receiving part and slits adjacent to the permanent magnet receiving part and extended to an end portion in a radial direction are formed to concentrate magnetic fluxes, such that a torque is increased and a torque ripple is decreased, and an interior permanent magnet synchronous motor including the same.

According to a preferred embodiment of the present invention, there is provided a rotor for an interior permanent magnet synchronous motor, the rotor including: a rotor core having a through-hole formed in an axial direction so that a shaft is press-fitted thereinto, a permanent magnet receiving part formed at an outer peripheral portion thereof in a circumferential direction so that a permanent magnet is inserted thereinto, and slits formed to be adjacent to the permanent magnet receiving part and be extended toward a circumferential end in a radial direction; and at least one permanent magnet inserted into the permanent magnet receiving part.

The permanent magnet receiving part may be a U-shaped permanent magnet receiving part having a U shape.

Three permanent magnets having the same size may be inserted into the U-shaped permanent magnet receiving part.

An interval between the slits may become narrower as the slits are extended toward the circumferential end.

The permanent magnet receiving part may be a U-shaped permanent magnet receiving part having a U shape, three permanent magnets having the same size may be inserted into the U-shaped permanent magnet receiving part, and the slits may be formed to be adjacent to boundary portions between the permanent magnets adjacent to each other and be extended toward the circumferential end in the radial direction.

According to another preferred embodiment of the present invention, there is provided an interior permanent magnet synchronous motor including: a rotor including a rotor core having a through-hole formed in an axial direction so that a shaft is press-fitted thereinto, a permanent magnet receiving part formed at an outer peripheral portion thereof in a circumferential direction so that a permanent magnet is inserted thereinto, and slits formed to be adjacent to the permanent magnet receiving part and be extended toward a circumferential end in a radial direction and at least one permanent magnet inserted into the permanent magnet receiving part; and a stator having the rotor positioned at an inner diameter portion thereof and having teeth formed to face the rotor and coils wound around the teeth.

The permanent magnet receiving part may be a U-shaped permanent magnet receiving part having a U shape.

Three permanent magnets having the same size may be inserted into the U-shaped permanent magnet receiving part.

An interval between the slits may be become narrower as the slits are extended toward the circumferential end.

The permanent magnet receiving part may be a U-shaped permanent magnet receiving part having a U shape, three permanent magnets having the same size may be inserted into the U-shaped permanent magnet receiving part, and the slits may have one ends formed to be adjacent to the permanent magnet receiving unit and be adjacent to boundary portions between the permanent magnets adjacent to each other and the other ends formed to be concentrated toward the teeth of the stator.

An interval between one end portions of the slits adjacent to the U shaped permanent magnet receiving part may be wider than an interval between the other end portions of the slits adjacent to the teeth of the stator.

An angle between the permanent magnets adjacent to each other may be smaller than the double of an angle between the slit and the U shape permanent magnet receiving part.

The sum of a distance between the centers at end portions of the slits formed to be concentrated toward an end portion of the teeth of the stator and a distance between the end portions of the slits may be the same as the double of a length of the teeth of the stator facing the end portions of the slits.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram schematically showing a rotor for an interior permanent magnet synchronous motor according to a preferred embodiment of the present invention;

FIG. 2 is a configuration diagram schematically showing a rotor for an interior permanent magnet synchronous motor and an interior permanent magnet synchronous motor including the same;

FIG. 3 is a schematic configuration diagram for forming a slit according to an optimal structure in the rotor shown in FIG. 2;

FIG. 4 is a graph in which a torque of the interior permanent magnet synchronous motor including the rotor for an interior permanent magnet synchronous motor according to the preferred embodiment of the present invention is compared with that of the interior permanent magnet synchronous motor according to the prior art; and

FIG. 5 is a graph in which a torque ripple of the interior permanent magnet synchronous motor including the rotor for an interior permanent magnet synchronous motor according to the preferred embodiment of the present invention is compared with that of the interior permanent magnet synchronous motor according to the prior art.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

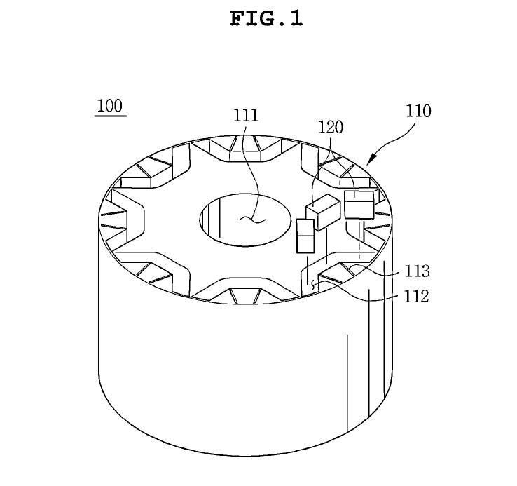

FIG. 1 is a configuration diagram schematically showing a rotor for an interior permanent magnet synchronous motor according to a preferred embodiment of the present invention. As shown in FIG. 1, the rotor 100 for an interior permanent magnet synchronous motor is configured to include a rotor core 110 and a permanent magnet 120 inserted into and mounted in the rotor core 110.

More specifically, the rotor core 110 includes a through-hole 111 into which a shaft (not shown) is press-fitted and a permanent magnet receiving part 112 formed at an outer peripheral portion thereof in a circumferential direction so that the permanent magnet receiving part 112 into which at least one permanent magnet 120 is inserted. In addition, the permanent magnet receiving part 112 may have a U shape so that three magnets having the same size may be inserted thereinto.

Further, the rotor core 110 includes slits 113 formed in order to reduce a torque ripple due to the permanent magnet inserted into the permanent magnet receiving part 112. In addition, the slits 113 are formed to be adjacent to the permanent magnet receiving part 112 and be extended toward a circumferential end in a radial direction.

In addition, two slits 113 are formed in one U shaped permanent magnet receiving part 112 so as to be adjacent to boundary portions between magnets adjacent to each other among three magnets inserted into the U shaped permanent magnet receiving part 112, and an interval between two slits 113 becomes narrower as the slits 113 are extended toward the circumferential end.

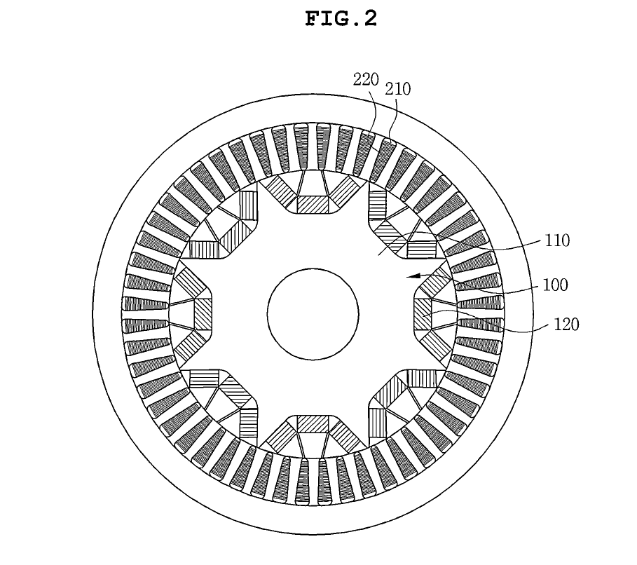

FIG. 2 is a configuration diagram schematically showing a rotor for an interior permanent magnet synchronous motor and an interior permanent magnet synchronous motor including the same. As shown in FIG. 2, the interior permanent magnet synchronous motor includes a rotor 100 and a stator 200.

More specifically, the rotor 100 is the same as the rotor 100 for an interior permanent magnet synchronous motor shown in FIG. 1 and is positioned at an inner diameter portion of the stator 200.

In addition, the stator includes teeth 210 formed to face the rotor 100 and coils 220 wound around the teeth 210.

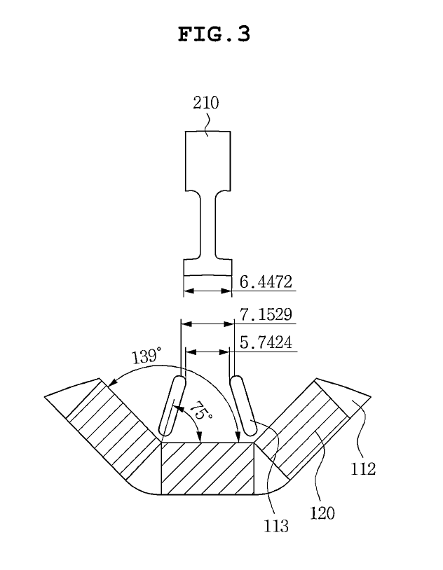

Hereinafter, an optimal structure of the rotor for an interior permanent magnet synchronous motor according to the preferred embodiment of the present invention for the stator will be describe in detail with reference to FIG. 3.

FIG. 3 is a schematic configuration diagram for forming a slit according to an optimal structure in the rotor shown in FIG. 2. As shown in FIG. 3, a U shaped permanent magnet receiving part 112 of the rotor for an interior permanent magnet synchronous motor has both ends that becomes wider toward a circumference end portion in a radius direction of the rotor so that one or more magnet, more specifically, three magnets having the same size may be inserted thereinto.

Further, each of the two slits 113 is formed to be adjacent to the boundary portions between the magnets adjacent to each other and is formed to be concentrated toward an end portion of the teeth 210 of the stator.

That is, an interval between one end portions of the slits 113 adjacent to the U shaped permanent magnet receiving part 112 is wider than an interval between the other end portions of the slits 113 adjacent to the teeth 210 of the stator. That is, the slits 113 are formed to be concentrated toward the teeth 210 of the stator.

In order to perform the optimal design for more efficient implementation, it is preferable that an angle between the permanent magnets adjacent to each other is smaller than the double of an angle between the slit 113 and the U shape permanent magnet receiving part 112. That is, as shown in FIG. 3, the angle between the permanent magnets adjacent to each other is 139 degrees and the angle between the slit 113 and the U shape permanent magnet receiving part 112 is 75 degrees. As a result, the angle between the permanent magnets is smaller than the double of the angle between the slit 113 and the U shape permanent magnet receiving part 112.

In addition, the sum of a distance between the centers at end portions of the slits 113 formed to be concentrated toward the end portion of the teeth 210 of the stator and a distance between the end portions of the slits 113 may be similar to the double of a length of the teeth 210 of the stator facing the end portions of the slits 113. That is, in the case in which the distance between the centers at the end portions of the slits 113 is 7.1529 mm and the distance between the end portions of the slits 113 is 5.7424 mm, the sum of the distances is 12.8953 mm, and in the case in which the length of the teeth 210 of the stator facing the end portions of the slits 113 is 6.4472 mm, 12.8944 mm, which is the double of 6.4472 mm, is similar to 12.8953 mm.

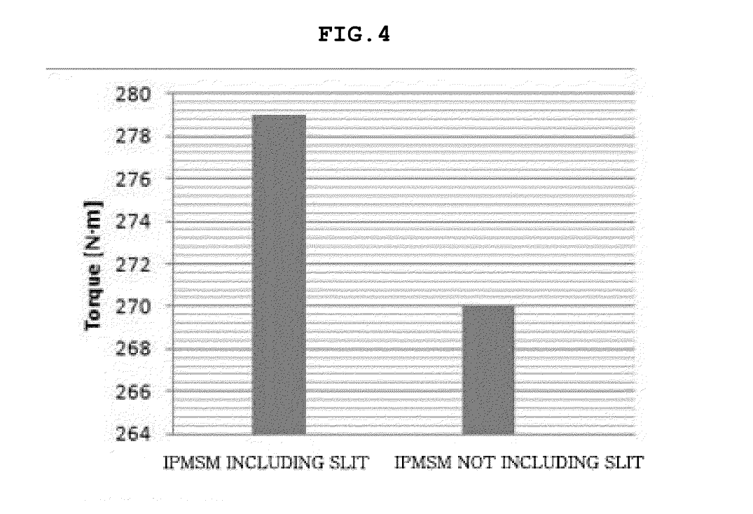

FIG. 4 is a graph in which a torque of the interior permanent magnet synchronous motor according to the preferred embodiment of the present invention is compared with that of the interior permanent magnet synchronous motor according to the prior art. In FIG. 4, the interior permanent magnet synchronous motor according to the preferred embodiment of the present invention is shown as an IPMSM including a slit, and the interior permanent magnet synchronous motor according to the prior art is shown as an IPMSM not including a slit. As shown in FIG. 4, the IPMSM including the slit has a torque of about 289 N·M, and the IPMSM not including the slit has a torque of about 270 N·M.

Therefore, it could be appreciated that the torque of the interior permanent magnet synchronous motor according to the preferred embodiment of the present invention including the slit has increased as compared with that of the IPMSM according to the related art not including the slit.

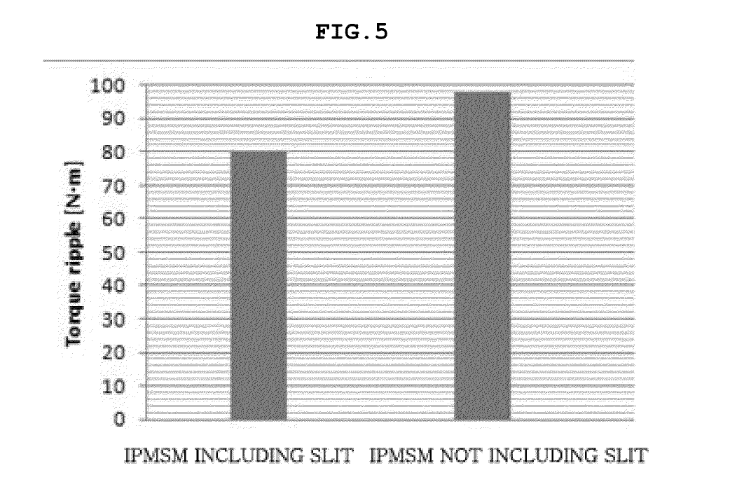

FIG. 5 is a graph in which a torque ripple of the interior permanent magnet synchronous motor including the rotor for an interior permanent magnet synchronous motor according to the preferred embodiment of the present invention is compared with that of the interior permanent magnet synchronous motor according to the prior art. In FIG. 5, the interior permanent magnet synchronous motor according to the preferred embodiment of the present invention is shown as an IPMSM including a slit, and the interior permanent magnet synchronous motor according to the prior art is shown as an IPMSM not including a slit. As shown in FIG. 5, the IPMSM including the slit has a torque ripple of about 80 N·M, and the IPMSM not including the slit has a torque ripple of about 98 N·M.

Therefore, it could be appreciated that the torque ripple of the interior permanent magnet synchronous motor according to the preferred embodiment of the present invention including the slit was smaller than that of the IPMSM according to the related art not including the slit.

Therefore, it may be appreciated that the interior permanent magnet synchronous motor including the rotor for an interior permanent magnet synchronous motor includes three permanent magnets inserted into the U shaped permanent magnet receiving part and the slits, such that it may have a torque increased and a torque ripple decreased, as compared with the interior permanent magnet synchronous motor according to the related art.

As set forth above, according to the preferred embodiments of the present invention, it is possible to obtain the rotor for an interior permanent magnet synchronous motor in which three permanent magnets are mounted in the U shaped permanent magnet receiving part and the slits adjacent to the U permanent magnet receiving part and extended to the end portion in the radial direction are formed to concentrate the magnetic fluxes, such that a torque is increased and a torque ripple is decreased and the interior permanent magnet synchronous motor including the same.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A rotor for an interior permanent magnet synchronous motor, the rotor comprising:
a rotor core having a through-hole formed in an axial direction so that a shaft is press-fitted thereinto, a permanent magnet receiving part formed at an outer peripheral portion thereof in a circumferential direction so that a permanent magnet is inserted thereinto, and slits formed to be adjacent to the permanent magnet receiving part and be extended toward a circumferential end in a radial direction; and
at least one permanent magnet inserted into the permanent magnet receiving part.

2. The rotor as set forth in claim 1, wherein the permanent magnet receiving part is a U-shaped permanent magnet receiving part having a U shape.

3. The rotor as set forth in claim 2, wherein three permanent magnets having the same size are inserted into the U-shaped permanent magnet receiving part.

4. The rotor as set forth in claim 1, wherein an interval between the slits becomes narrower as the slits are extended toward the circumferential end.

5. The rotor as set forth in claim 1, wherein the permanent magnet receiving part is a U-shaped permanent magnet receiving part having a U shape, three permanent magnets having the same size are inserted into the U-shaped permanent magnet receiving part, and the slits are formed to be adjacent to boundary portions between the permanent magnets adjacent to each other and be extended toward the circumferential end in the radial direction.

6. An interior permanent magnet synchronous motor comprising:
a rotor including a rotor core having a through-hole formed in an axial direction so that a shaft is press-fitted thereinto, a permanent magnet receiving part formed at an outer peripheral portion thereof in a circumferential direction so that a permanent magnet is inserted thereinto, and slits formed to be adjacent to the permanent magnet receiving part and be extended toward a circumferential end in a radial direction and at least one permanent magnet inserted into the permanent magnet receiving part; and
a stator having the rotor positioned at an inner diameter portion thereof and having teeth formed to face the rotor and coils wound around the teeth.

7. The interior permanent magnet synchronous motor as set forth in claim 6, wherein the permanent magnet receiving part is a U-shaped permanent magnet receiving part having a U shape.

8. The interior permanent magnet synchronous motor as set forth in claim 7, wherein three permanent magnets having the same size are inserted into the U-shaped permanent magnet receiving part.

9. The interior permanent magnet synchronous motor as set forth in claim 6, wherein an interval between the slits becomes narrower as the slits are extended toward the circumferential end.

10. The interior permanent magnet synchronous motor as set forth in claim 6, wherein the permanent magnet receiving part is a U-shaped permanent magnet receiving part having a U shape, three permanent magnets having the same size are inserted into the U-shaped permanent magnet receiving part, and the slits have one ends formed to be adjacent to the permanent magnet receiving part and be adjacent to boundary portions between the permanent magnets adjacent to each other and the other ends formed to be concentrated toward the teeth of the stator.

11. The interior permanent magnet synchronous motor as set forth in claim 10, wherein an interval between one end portions of the slits adjacent to the U shaped permanent magnet receiving part is wider than an interval between the other end portions of the slits adjacent to the teeth of the stator.

12. The interior permanent magnet synchronous motor as set forth in claim 11, wherein an angle between the permanent magnets adjacent to each other is smaller than the double of an angle between the slit and the U shape permanent magnet receiving part.

13. The interior permanent magnet synchronous motor as set forth in claim 11, wherein the sum of a distance between the centers at end portions of the slits formed to be concentrated toward an end portion of the teeth of the stator and a distance between the end portions of the slits is the same as the double of a length of the teeth of the stator facing the end portions of the slits.
